(19) United States
(12) Patent Application Publication
(10) Pub. No.: US 2015/0027643 A1
(43) Pub. Date: Jan. 29, 2015

(54) EVAPORATION APPARATUS

(71) Applicant: Samsung Display Co., Ltd., Yongin-City (KR)

(72) Inventors: Chul-Hwan Park, Yongin-City (KR); Nam-Jin Kim, Yongin-City (KR)

(73) Assignee: Samsung Display Co., Ltd., Yongin-City (KR)

(21) Appl. No.: 14/205,917

(22) Filed: Mar. 12, 2014

(30) Foreign Application Priority Data
Jul. 25, 2013 (KR) 10-2013-0088080

(51) Int. Cl. B01D 1/16

(52) U.S. Cl. CPC B01D 1/16
USPC 159/4.01

(57) ABSTRACT

An evaporation apparatus includes a vaporization chamber including a liquid inlet and a vapor outlet, a spray chamber which is connected to the vaporization chamber and sprays a vapor which has flowed out from the vapor outlet of the vaporization chamber, and a release chamber which is connected to the vaporization chamber and reduces a pressure of the vapor which has flowed out from the vapor outlet of the vaporization chamber.

This application claims priority to Korean Patent Application No. 10-2013-0088080, filed on Jul. 25, 2013, and all the benefits accruing therefrom under 35 U.S.C. §119, the disclosure of which is incorporated herein in its entirety by reference.

### BACKGROUND

1. Field

One or more exemplary embodiment of the invention relates to evaporation apparatuses for flash evaporation, and more particularly, to evaporation apparatuses that have an improved pipe structure between a vaporization chamber and a spray chamber and thus reduce a particle level in a gas.

2. Description of the Related Art

Liquid (e.g., a single or compound composition) flash evaporation methods use an ultrasonic nozzle to atomize a liquid into droplets and disperse the droplets in a high-temperature container (e.g., evaporator). The droplets are directly vaporized without being boiled when contacting a wall of the evaporator. This process prevents the composition of the liquid from being separated or distilled, thus maintaining a vapor-phase uniform liquid composition.

However, while the liquid is being vaporized and moved, the droplets may be evaporated and adhered to a pipe that connects a vaporization chamber and a spray chamber. In particular, as the saturated vapor pressure of an evaporated material decreases, the contamination in equipment becomes more serious. Furthermore, as the time of use of an evaporation apparatus increases, the amount of evaporated materials deposited in the vaporization chamber and the pipe increases. When the amount of adhered evaporated materials exceeds a predetermined level, adhered evaporated materials are stripped (or separated) from the pipe. The resulting separated particles are moved to a substrate through the pipe and are undesirably deposited on the substrate, thus degrading a deposition quality and causing defective products.

### SUMMARY

One or more exemplary embodiment of the invention includes an evaporation apparatus that has an improved pipe structure between a vaporization chamber and a spray chamber and thus reduces a particle level in a gas.

Additional features will be set forth in part in the description which follows and, in part, will be apparent from the description, or may be learned by practice of the exemplary embodiments.

According to one or more exemplary embodiment of the invention, an evaporation apparatus includes: a vaporization chamber including a liquid inlet and a vapor outlet; a spray chamber which is connected to the vaporization chamber and sprays a vapor which has flowed out from the vapor outlet of the vaporization chamber; and a release chamber which is connected to the vaporization chamber and the spray chamber and reduces a pressure of the vapor which has flowed out from the vapor outlet of the vaporization chamber.

The evaporation apparatus may further include: a first pipe which connects the vaporization chamber and the release chamber; and a second pipe which connects the release chamber and the spray chamber. A cross-sectional area of the first pipe may be smaller than a cross-sectional area of the release chamber, and the cross-sectional area of the first pipe may be smaller than or equal to a cross-sectional area of the second pipe.

The vapor which has flowed out from the vapor outlet may include particles, and the release chamber separates the particles from the vapor which has flowed out from the vapor outlet.

The evaporation apparatus may further include a plurality of filter members in the release chamber.

The plurality of filter members may be spherical or polyhedral micro-structures.

The plurality of filter members may be further in the spray chamber.

The evaporation apparatus may further include a plurality of release chambers which is spaced apart from each other, and a pipe which connects the plurality of release chambers to each other.

The evaporation apparatus may further include a plurality of release chambers, including a first release chamber and a second release chamber which are spaced apart from each other; a first pipe which connects the vaporization chamber and the first release chamber to each other; a second pipe which connects the first release chamber and the second release chamber to each other; and a third pipe which connects the second release chamber and the spray chamber to each other. A cross-sectional area of the first pipe may be smaller than or equal to a cross-sectional area of the second pipe, and the cross-sectional area of the second pipe may be smaller than or equal to a cross-sectional area of the third pipe.

The evaporation apparatus may further include a plurality of filter members respectively in the first and second release chambers, and a size of the filter member in the second release chamber may be smaller than or equal to a size of the filter member in the first release chamber.

The release chamber and the spray chamber may be integrated with each other.

According to one or more exemplary embodiment of the invention, an evaporation apparatus includes: a vaporization chamber including a liquid inlet and a vapor outlet; a spray chamber including a spray nozzle which is configured to spray a vapor which has flowed out from the vapor outlet of the vaporization chamber; and a filter member which is between the vaporization chamber and the spray nozzle and filters out particles in the vapor which has flowed out from the vapor outlet of the vaporization chamber.

The filter member may be a spherical or polyhedral micro-structure.

The filter member may be in the spray chamber.

The evaporation apparatus may further include a release chamber which connects the vaporization chamber and the spray chamber and reduces a pressure of the vapor which has flowed out from the vapor outlet of the vaporization chamber.

The filter member may be in the release chamber.

The evaporation apparatus may further include: a first pipe which connects the vaporization chamber and the release chamber; and a second pipe which connects the release chamber and the spray chamber. A cross-sectional area of the first pipe may be smaller than a cross-sectional area of the release chamber, and the cross-sectional area of the first pipe may be smaller than or equal to a cross-sectional area of the second pipe.

The evaporation apparatus may further include a plurality of release chambers which is spaced apart from each other and a pipe which connects the plurality of release chambers to each other.

The evaporation apparatus may further include a plurality of release chambers, including a first release chamber and a second release chamber which are spaced apart from each other; a first pipe which connects the vaporization chamber and the first release chamber to each other; a second pipe which connects the first release chamber and the second release chamber to each other; and a third pipe which connects the second release chamber and the spray chamber to each other. A cross-sectional area of the first pipe may be smaller than or equal to a cross-sectional area of the second pipe, and the cross-sectional area of the second pipe may be smaller than or equal to a cross-sectional area of the third pipe.

The evaporation apparatus may further include a plurality of filter members respectively in the first and second release chambers. A size of the filter member in the second release chamber may be smaller than or equal to a size of the filter member in the first release chamber.

The release chamber may separate particles from the vapor which has flowed out from the vapor outlet.

### BRIEF DESCRIPTION OF THE DRAWINGS

These and/or other features will become apparent and more readily appreciated from the following description of the exemplary embodiments, taken in conjunction with the accompanying drawings in which:

FIG. 1 is a cross-sectional view of an exemplary embodiment of an evaporation apparatus according to the invention;

FIG. 2 is a cross-sectional view illustrating an exemplary embodiment of an air flow in the evaporation apparatus of FIG. 1;

FIG. 3 is a cross-sectional view of another exemplary embodiment of an evaporation apparatus according to the invention;

FIG. 4 is a cross-sectional view of still another exemplary embodiment of an evaporation apparatus according to the invention; and

FIG. 5 is a cross-sectional view of yet another exemplary embodiment of an evaporation apparatus according to the invention.

### DETAILED DESCRIPTION

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain features of the invention.

Hereinafter, exemplary embodiments of the invention will be described in detail with reference to the accompanying drawings. The invention may, however, be embodied in many different forms and should not be construed as being limited to the exemplary embodiments set forth herein; rather, these exemplary embodiments are provided so that this disclosure will be thorough and complete, and will fully convey the concept of the invention to those of ordinary skill in the art. Like reference numerals in the drawings denote like elements throughout.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically and/or fluidly connected to each other. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

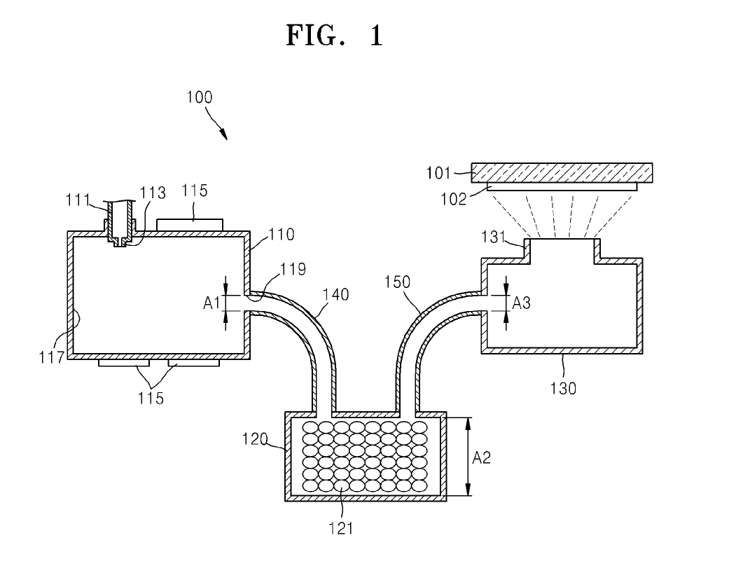

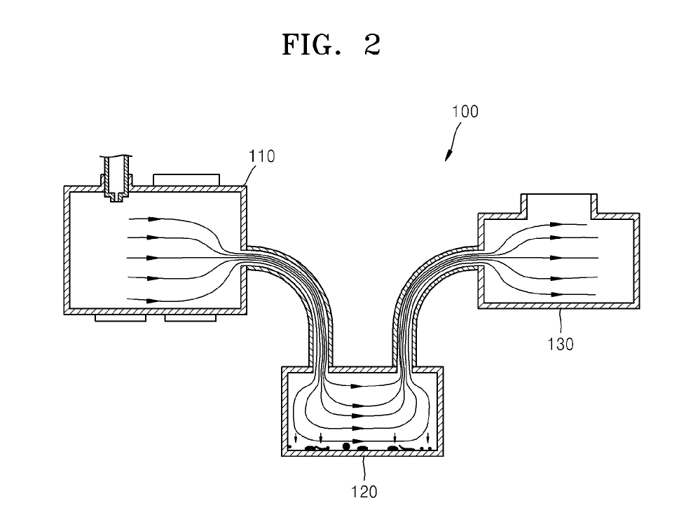

FIG. 1 is a cross-sectional view of an exemplary embodiment of an evaporation apparatus 100 according to the invention. FIG. 2 is a cross-sectional view illustrating an exemplary embodiment of an air flow in the evaporation apparatus 100 of FIG. 1.

Referring to FIGS. 1 and 2, the evaporation apparatus 100 according to the invention includes a vaporization chamber 110, a release chamber 120 and a spray chamber 130. The evaporation apparatus 100 may further include a first pipe 140 connecting the vaporization chamber 110 and the release chamber 120 to each other, and a second pipe 150 connecting the release chamber 120 and the spray chamber 130 to each other.

The vaporization chamber 110 includes a liquid inlet 111, an atomizer 113, a heater 115, an inner surface 117 and a vapor outlet 119. The vaporization chamber 110 may be applied to various fluid (e.g., monomer, oligomer, and resin) systems, and exemplary embodiments of the invention are not limited thereto. The vaporization chamber 110 may include a housing which defines the inner surface 117 on various sidewalls thereof. A chamber space may be defined in the housing and the inner surface 117 is exposed to this chamber space.

When various liquids (or fluids), such as monomer, oligomer and resin, flow in and through the liquid inlet 111, the atomizer 113 may atomize the liquid which has flowed in and through the liquid inlet 111, into particles or droplets such as by using ultrasonic waves. However, exemplary embodiments of the invention are not limited thereto, and the atomizer 113 may also atomize the liquid into droplets by various processes other than ultrasonic waves. The atomizer 113 may be exposed to the chamber space of the vaporization chamber 110 and provide the atomized liquid into the chamber space.

The heater 115 heats the inner surface 117 of the vaporization chamber 110. That is, a monomer flow is atomized into particles or droplets through the atomizer 113, and the particles or droplets are flash-evaporated into a gas, a vapor or a compound vapor by colliding with the heated inner surface 117 of the vaporization chamber 110. The vapor generated in the vapor chamber 110 is transmitted through the vapor outlet 119 to the release chamber 120.

The release chamber 120 is connected to the vapor outlet 119 of the vaporization chamber 110 through the first pipe 140, and the generated vapor flows into the release chamber 120. The release chamber 120 may include a housing which defines an inner area of the release chamber 120. An inlet of the release chamber 120 is connected to the vapor outlet 119 of the vaporization chamber 110, while an outlet of the release chamber 120 is connected to an inlet of the spray chamber 130. Respective inlets and outlets may be in fluid and/or physical connection with each other. A plurality of filter members 121 may be provided in the release chamber 120, such as in the inner area of the release chamber 120. The filter members 121 may include bead-shaped micro-structures, but are not limited thereto. The release chamber 120 is described later in more detail.

The spray chamber 130 is connected to the release chamber 120 through the second pipe 150, and a vapor, which has passed through the release chamber 120, flows into the spray chamber 130. The vapor, which has flowed into the spray chamber 130, is sprayed through a spray nozzle 131 and is condensed to form a liquid thin film 102 on a surface of a substrate 101 to be coated. In an exemplary embodiment, the liquid thin film 102 is hardened such as to form an organic thin film.

In the evaporation apparatus 100, the release chamber 120 provided between the vaporization chamber 110 and the spray chamber 130 reduces the pressure of a moving vapor to cause the particles contained in the vapor to fall free in the release chamber 120, thereby reducing a particle level in the vapor.

In general flash evaporation, particles are generated while a source material is being vaporized, moved and sprayed. When the generated particles are adhered to a pipe connecting a vaporization chamber and a spray chamber, the contamination in equipment becomes serious. When the amount of adhered evaporated materials exceeds a predetermined level, adhered evaporated materials are stripped (or separated) from the pipe. The resulting separated particles are moved to a substrate through the pipe and are undesirably deposited on a substrate, thus degrading a deposition quality and causing defective products.

In order to overcome this problem, according to one or more exemplary embodiment of the invention, a pressure-reducing space (i.e., the release chamber 120) is provided in the middle of the pipe or at a spray nozzle portion to increase the control power of gravity acting on the moving particles contained in the air flow, thereby causing the particles to fall free. In addition, the pressure-reducing space is filled with bead-shaped micro-structures, thereby filtering out the particles, as described below in more detail.

Referring to FIGS. 1 and 2, the evaporation apparatus 100 includes the release chamber 120 between the vaporization chamber 110 and the spray chamber 130. The first pipe 140 is curved in a U shape and has a cross-sectional area A1, as illustrated in FIG. 1. The release chamber 120, which includes a relatively wide space defined therein, is capable of reducing a pressure from that in the first pipe 140. The release chamber 120 is disposed at a bottom portion (or in a flow direction) of the first pipe 140, to reduce the speed of a moving vapor in the first pipe 140 and cause the moving particles contained in the vapor to fall free in the release chamber 120. FIG. 2 illustrates particles at the bottom of the release chamber 120 while the vapor continues onto the second pipe 150.

Herein, the cross-sectional area A1 of the first pipe 140 may be smaller than a cross-sectional area A2 of the release chamber 120. Also, the cross-sectional area A1 of the first pipe 140 may be smaller than or equal to a cross-sectional area A3 of the second pipe 150. While the cross-sectional area A2 of the release chamber 120 is indicated in a direction substantially parallel to the flow direction of the first pipe 140, the cross-sectional area A2 of the release chamber 120 may also be taken in a direction substantially perpendicular to the flow direction of the first pipe 140 and/or the second pipe 150.

The plurality of filter members 121 may be further provided in the release chamber 120. In one exemplary embodiment, for example, the release chamber 120 may be filled with discrete bead-shaped filter members 121, thereby inducing a vapor flow between the filter members 121, and providing filtering of the particles. Although the filter members 121 are illustrated as having a shape of a bead (e.g., curved such as spherical), exemplary embodiments of the invention are not limited thereto. In one exemplary embodiment, for example, the filter members 121 may have a shape of a regular hexahedron or an octahedron. The filter members 121 may be provided in a shape, size and/or number that promotes filtering of the particles contained in the vapor passing through the release chamber 120.

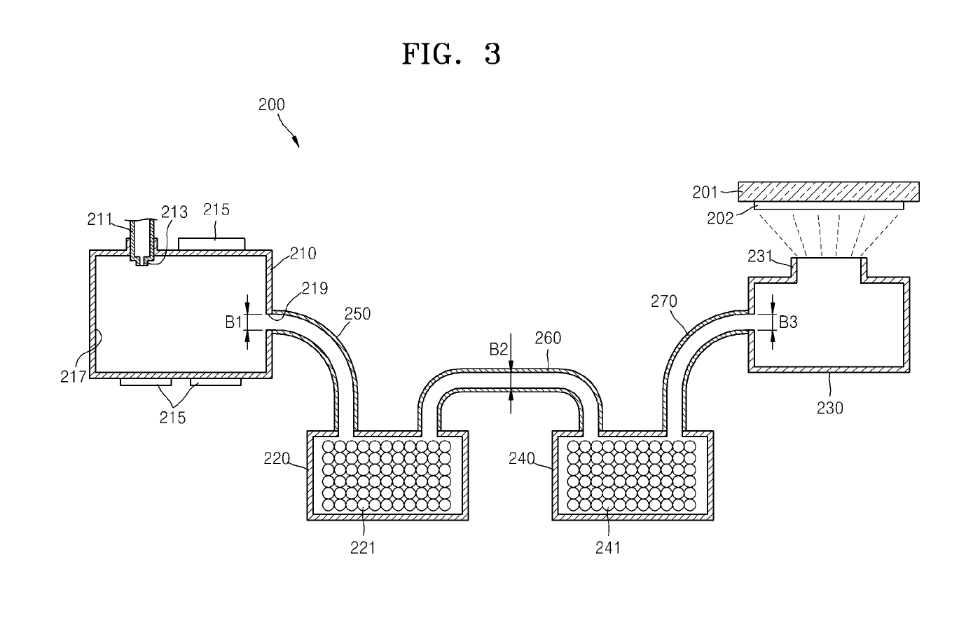

FIG. 3 is a cross-sectional view of another exemplary embodiment of an evaporation apparatus 200 according to the invention. Referring to FIG. 3, the evaporation apparatus 200 according to the invention includes a vaporization chamber 210, a first release chamber 220, a second release chamber 240 and a spray chamber 230. The evaporation apparatus 200 may further include a first pipe 250 connecting the vaporization chamber 210 and the first release chamber 220 to each other, a second pipe 260 connecting the first release chamber 220 and the second release chamber 240 to each other, and a third pipe 270 connecting the second release chamber 240 and the spray chamber 230 to each other.

The vaporization chamber 210 includes a liquid inlet 211, an atomizer 213, a heater 215, an inner surface 217 and a vapor outlet 219. A plurality of filter members 221 may be provided in the first release chamber 220, and a plurality of filter members 241 may be provided in the second release chamber 240. A vapor that has passed through the first and second release chambers 220 and 240 flows into the spray chamber 230. The vapor, which has flowed into the spray chamber 230, is sprayed through a spray nozzle 231 and is condensed to form a liquid thin film 202 on a surface of a substrate 201 to be coated. In an exemplary embodiment, the liquid thin film 202 is hardened such as to form an organic thin film.

The evaporation apparatus 200 is different from the evaporation apparatus 100 in that the evaporation apparatus 200 includes a plurality of release chambers. The plurality of release chambers 220 and 240 are connected in series.

As illustrated in FIG. 3, the evaporation apparatus 200 includes the first and second release chambers 220 and 240 to consecutively provide a plurality of temperature-release spaces filled with the filter members 221 and 241, thereby further increasing particle-capturing capability.

Herein, a cross-sectional area B1 of the first pipe 250 may be smaller than or equal to a cross-sectional area B2 of the second pipe 260, and the cross-sectional area B2 of the second pipe 260 may be smaller than or equal to a cross-sectional area B3 of the third pipe 270. Also, the size of the filter members 241 provided in the second release chamber 240 may be equal to or smaller than the size of the filter members 221 provided in the first release chamber 220.

Although two release chambers are illustrated in FIG. 3, exemplary embodiments of the invention are not limited thereto. Three or more release chambers may be provided according to the specification requirements of the evaporation apparatus.

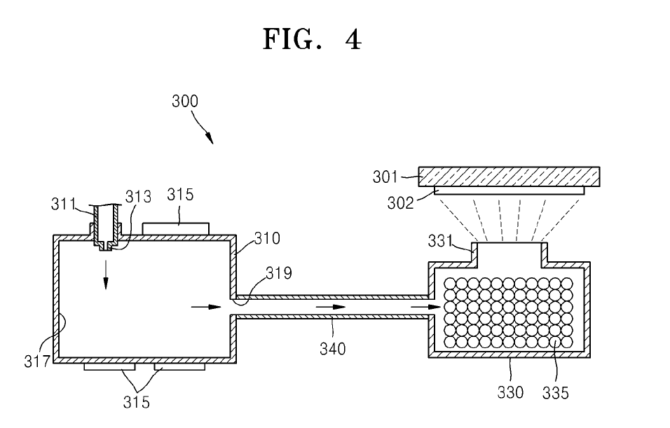

FIG. 4 is a cross-sectional view of still another exemplary embodiment of an evaporation apparatus 300 according to the invention. Referring to FIG. 4, the evaporation apparatus 300 according to the invention includes a vaporization chamber 310 and a spray chamber 330. The evaporation apparatus 300 may further include a first pipe 340 connecting the vaporization chamber 310 and the spray chamber 330 to each other.

The vaporization chamber 310 includes a liquid inlet 311, an atomizer 313, a heater 315, an inner surface 317 and a vapor outlet 319. A vapor that has passed through the first pipe 340 flows into the spray chamber 330. The vapor, which has flowed into the spray chamber 330, is sprayed through a spray nozzle 331 and is condensed to form a liquid thin film 302 on a surface of a substrate 301 to be coated. In an exemplary embodiment, the liquid thin film 302 is hardened such as to form an organic thin film. A plurality of filter members 335 may be provided in the spray chamber 330.

Herein, the cross-sectional area of the first pipe 340 may be smaller than a cross-sectional area of the spray chamber 330. The spray chamber 330 which includes a relatively wide inner space defined therein, is capable of reducing a pressure from that in the first pipe 340. The spray chamber 330 is disposed in a flow direction of the first pipe 340, to reduce the speed of a moving vapor in the first pipe 340 and cause the moving particles contained in the vapor to fall free in the spray chamber 330. The filter members 335 disposed in the spray chamber 330 induce a vapor flow between the filter members 335, and providing filtering of the particles.

The evaporation apparatus 300 is different from the evaporation apparatus 100 in that the evaporation apparatus 300 includes a plurality of filter members 335 provided in the spray chamber 330, instead of including a release chamber, and the spray chamber 330 also functions as a release chamber. That is, in the evaporation apparatus 300, a spray chamber and a release chamber are integrated with each other. In this manner, since a plurality of filter members 335 is provided in the spray chamber 330, the spray chamber 330 also functions as a release chamber, thereby providing filtering of the moving particles contained in the vapor flow, even without changing the internal configuration of a related art flash evaporation apparatus.

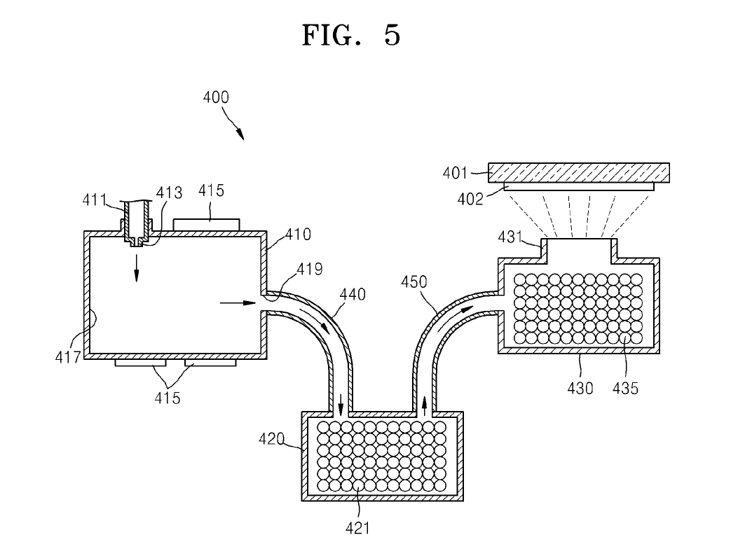

FIG. 5 is a cross-sectional view of yet another exemplary embodiment of an evaporation apparatus 400 according to the invention. Referring to FIG. 5, the evaporation apparatus 400 according to the invention includes a vaporization chamber 410, a release chamber 420 and a spray chamber 430. The evaporation apparatus 400 may further include a first pipe 440 connecting the vaporization chamber 410 and the release chamber 420 to each other, and a second pipe 450 connecting the release chamber 420 and the spray chamber 430 to each other.

The vaporization chamber 410 includes a liquid inlet 411, an atomizer 413, a heater 415, an inner surface 417 and a vapor outlet 419. A plurality of filter members 421 may be provided in the release chamber 420. A vapor that has passed through the release chamber 420 flows into the spray chamber 430. The vapor, which has flowed into the spray chamber 430, is sprayed through a spray nozzle 431 and is condensed to form a liquid thin film 402 on a surface of a substrate 401 to be coated. In an exemplary embodiment, the liquid thin film 402 is hardened such as to form an organic thin film.

The evaporation apparatus 400 is different from the evaporation apparatus 100 in that the evaporation apparatus 400 further includes a plurality of filter members 435 provided in the spray chamber 430, such that the spray chamber 430 also functions as a release chamber. In this manner, since a plurality of filter members 435 are further provided in the spray chamber 430, the release chamber 420 and the spray chamber 430 enable the evaporation apparatus 400 to capture particles twice, thereby making it possible to further increase particle-capturing capability.

As described above, according to one or more of the above exemplary embodiments of the invention, the moving particles contained in the vapor flow are induced to fall free, thereby reducing or effectively preventing contamination in the evaporation apparatus, increasing the operation time of the evaporation apparatus, and improving a deposition quality of a thin film.

It should be understood that the exemplary embodiments described therein should be considered in a descriptive sense only and not for purposes of limitation. Descriptions of features within each exemplary embodiment should typically be considered as available for other similar features in other exemplary embodiments.

While one or more exemplary embodiment of the invention has been described with reference to the figures, it will be understood by those of ordinary skill in the art that various changes in form and details may be made therein without departing from the spirit and scope of the invention as defined by the following claims.

What is claimed is:

1. An evaporation apparatus comprising:
a vaporization chamber comprising a liquid inlet and a vapor outlet;
a spray chamber which is connected to the vaporization chamber and sprays a vapor which has flowed out from the vapor outlet of the vaporization chamber; and
a release chamber which is connected to the vaporization chamber and the spray chamber, and reduces a pressure of the vapor which has flowed out from the vapor outlet of the vaporization chamber.

2. The evaporation apparatus of claim 1, further comprising:
a first pipe which connects the vaporization chamber and the release chamber to each other; and
a second pipe which connects the release chamber and the spray chamber to each other,
wherein
a cross-sectional area of the first pipe is smaller than a cross-sectional area of the release chamber, and
the cross-sectional area of the first pipe is smaller than or equal to a cross-sectional area of the second pipe.

3. The evaporation apparatus of claim 1, wherein the vapor which has flowed out from the vapor outlet comprises particles, and the release chamber separates the particles from the vapor which has flowed out from the vapor outlet.

4. The evaporation apparatus of claim 1, further comprising a plurality of filter members in the release chamber.

5. The evaporation apparatus of claim 4, wherein the plurality of filter members is respectively spherical or polyhedral micro-structures.

6. The evaporation apparatus of claim 4, wherein the plurality of filter members is further in the spray chamber.

7. The evaporation apparatus of claim 1, further comprising
a plurality of release chambers which is spaced apart from each other, and
a pipe which connects the plurality of release chambers to each other.

8. The evaporation apparatus of claim 1, further comprising:
a plurality of release chambers, comprising a first release chamber and a second release chamber which are spaced apart from each other;
a first pipe which connects the vaporization chamber and the first release chamber to each other;
a second pipe which connects the first release chamber and the second release chamber to each other; and
a third pipe which connects the second release chamber and the spray chamber to each other,
wherein
a cross-sectional area of the first pipe is smaller than or equal to a cross-sectional area of the second pipe, and the cross-sectional area of the second pipe is smaller than or equal to a cross-sectional area of the third pipe.

9. The evaporation apparatus of claim 8, further comprising a plurality of filter members respectively in the first and second release chambers,
wherein a size of the filter member in the second release chamber is smaller than or equal to a size of the filter member in the first release chamber.

10. The evaporation apparatus of claim 1, wherein
the spray chamber is the release chamber, such that the release chamber and the spray chamber are integrated with each other.

11. An evaporation apparatus comprising:
a vaporization chamber comprising a liquid inlet and a vapor outlet;
a spray chamber comprising a spray nozzle which is configured to spray a vapor which has flowed out from the vapor outlet of the vaporization chamber; and
a filter member which is between the vaporization chamber and the spray nozzle of the spray chamber and filters out particles in the vapor which has flowed out from the vapor outlet of the vaporization chamber.

12. The evaporation apparatus of claim 11, wherein the filter member comprises a spherical or polyhedral micro-structure.

13. The evaporation apparatus of claim 11, wherein the filter member is in the spray chamber.

14. The evaporation apparatus of claim 11, further comprising a release chamber which connects the vaporization chamber and the spray chamber to each other and reduces a pressure of the vapor which has flowed out from the vapor outlet of the vaporization chamber.

15. The evaporation apparatus of claim 14, wherein the filter member is in the release chamber.

16. The evaporation apparatus of claim 14, further comprising:
a first pipe which connects the vaporization chamber and the release chamber to each other; and
a second pipe which connects the release chamber and the spray chamber to each other,
wherein
a cross-sectional area of the first pipe is smaller than a cross-sectional area of the release chamber, and
the cross-sectional area of the first pipe is smaller than or equal to a cross-sectional area of the second pipe.

17. The evaporation apparatus of claim 14, further comprising a plurality of release chambers which is spaced apart from each other, and
a pipe which connects the plurality of release chambers to each other.

18. The evaporation apparatus of claim 14, further comprising:
a plurality of release chambers, comprising a first release chamber and a second release chamber which are spaced apart from each other;;
a first pipe which connects the vaporization chamber and the first release chamber to each other;
a second pipe which connects the first release chamber and the second release chamber to each other; and
a third pipe which connects the second release chamber and the spray chamber to each other,
wherein
a cross-sectional area of the first pipe is smaller than or equal to a cross-sectional area of the second pipe, and the cross-sectional area of the second pipe is smaller than or equal to a cross-sectional area of the third pipe.

19. The evaporation apparatus of claim 18, further comprising a plurality of filter members respectively in the first and second release chambers,
wherein a size of the filter member in the second release chamber is smaller than or equal to a size of the filter member in the first release chamber.

20. The evaporation apparatus of claim 14, wherein the release chamber separates the particles in the vapor which has flowed out from the vapor outlet.
